(19) United States
(12) Patent Application Publication
(10) Pub. No.: US 2025/0096632 A1
(43) Pub. Date: Mar. 20, 2025

(54) STATOR FOR AN AFPM MOTOR

(71) Applicants: HYUNDAI MOTOR COMPANY, Seoul (KR); KIA CORPORATION, Seoul (KR)

(72) Inventors: Dong Hee Lee, Hwaseong-si (KR); Ji Yeon Kim, Hwaseong-si (KR); Sang Jin Park, Hwaseong-si (KR); Sung Gon Byun, Hwaseong-si (KR)

(73) Assignees: HYUNDAI MOTOR COMPANY, Seoul (KR); KIA CORPORATION, Seoul (KR)

(21) Appl. No.: 18/825,153

(22) Filed: Sep. 5, 2024

(30) Foreign Application Priority Data
Sep. 15, 2023 (KR) 10-2023-0123252

(51) Int. Cl. H02K 3/52; H02K 21/24

(52) U.S. Cl. CPC H02K 3/522; H02K 21/24; H02K 2203/12

(57) ABSTRACT

An AFPM motor stator includes a plurality of stator cores in a circular arrangement. Each of the plurality of stator cores is shaped in a tapered shape. The stator also includes a plurality of bobbins each divided to be coupled to an outer side of each of the plurality of stator cores and a plurality of coils each wound along an outer circumferential surface of each of the plurality of bobbins. The stator also includes an inner housing provided in a shape of a hollow cylinder and supporting radially-inner portions of the plurality of bobbins each wound by a coil of the plurality of coils and includes an outer housing surrounding and supporting radially-outer portions of the plurality of bobbins each wound by the coil.

### CROSS-REFERENCE TO RELATED APPLICATION

This application claims priority to and the benefit of Korean Patent Application No. 10-2023-0123252, filed on Sep. 15, 2023, the entire content of which is hereby incorporated by reference.

### BACKGROUND

### Technical Field

The present disclosure relates to an axial flux permanent magnet (AFPM) motor stator and, more particularly, to an AFPM motor stator having a simple force transmission path and a robust structure using a reinforced bobbin.

### Discussion of Related Art

In general, a motor has a rotor with a magnet and a stator with a coil, and when a voltage is applied to the coil, the rotor rotates. The motor is provided in two types including an axial flux permanent magnet (AFPM) motor and a radial flux permanent magnet (RFPM) motor.

The AFPM motor has a shorter axial length compared to the RFPM motor and is thus greatly useful for a drive system that requires a motor with a short axial length.

A typical AFPM motor includes T-shaped supports inserted between stacked stator cores. The T-shaped supports may each be disposed between coils surrounding an outer circumferential surface of the stator cores to engage therewith.

The supports are assembled by engaging and being pressed in via press-fitting. Thus, a press-fitting amount may be small depending on a manufacturing tolerance and robustness may be degraded due to many force transmission paths between a directly supported support ring and a stator core. In addition, a T-shaped support may reduce an area of coils, which may reduce a space factor and degrade the motor performance. In addition, oil may not flow through between the coils, hindering integrated cooling.

The statements in this Background section merely provide background information related to the present disclosure and may not constitute prior art.

### SUMMARY

An object of the present disclosure is to provide an axial flux permanent (AFPM) motor stator that may effectively reduce the temperature of a coil.

Another object of the present disclosure is to provide an AFPM motor stator that may improve a space factor.

Another object of the present disclosure is to provide an AFPM motor stator that may secure a hollow space between coils to enable direct oil cooling.

Another object of the present disclosure is to provide an AFPM motor stator that may reduce the resistance of a coil.

To accomplish these and other objects, according to an embodiment of the present disclosure, an axial flux permanent magnet (AFPM) motor stator is provided.

In at least one embodiment of the present disclosure, an AFPM motor stator includes a plurality of stator cores in a circular arrangement, where each of the plurality of stator cores is shaped in a tapered shape. The stator also includes a plurality of bobbins each divided to be coupled to an outer side of each of the plurality of stator cores. The stator also includes a plurality of coils each wound along an outer circumferential surface of each of the plurality of bobbins. The stator further includes an inner housing having a shape of a hollow cylinder and supporting radially-inner portions of the plurality of bobbins each wound by a coil of the plurality of coils. The stator also includes an outer housing surrounding and supporting radially-outer portions of the plurality of bobbins each wound by the coil.

In at least one embodiment of the present disclosure, each of the plurality of bobbins includes two pieces coupled to each other to form each of the plurality of bobbins in a circumferential direction with respect to the circular arrangement.

In at least one embodiment of the present disclosure, each of the plurality of bobbins includes two pieces coupled to each other to form each of the plurality of bobbins. A dividing line divides the two pieces is transverse to a width direction of the each of the plurality of stator cores.

In at least one embodiment of the present disclosure, each of the plurality of bobbins includes a first half bobbin, i.e., a first part/piece of each of the plurality of bobbins, and a second half bobbin, i.e., a second part/piece of each of the plurality of bobbins, coupled to each other to form each of the plurality of bobbins with respect to a stacking direction of the plurality of stator cores.

In at least one embodiment of the present disclosure, a division line of the first half bobbin and the second half bobbin is above a middle of each of the plurality of bobbins in the stacking direction.

In at least one embodiment of the present disclosure, the plurality of bobbins is coupled to the inner housing and the outer housing by a plastic fusion method. The plastic fusion method may include any one of laser fusion, bonding, ultrasonic fusion, or the like.

In at least one embodiment of the present disclosure, each of the plurality of bobbins is made from engineering plastic.

In at least one embodiment of the present disclosure, the each of the plurality of bobbins is formed by an insert injection process of placing a corresponding stator core into a mold and injecting the engineering plastic.

In at least one embodiment of the present disclosure, the inner housing and the outer housing are formed of the engineering plastic.

In at least one embodiment of the present disclosure, the inner housing includes at least two parts coupled to each other to form the inner housing. The two parts are divided in a direction perpendicular to a stacking direction of the plurality of stator cores.

In at least one embodiment of the present disclosure, the outer housing includes at least two parts coupled to each other to form the outer housing. The at least two parts of the outer housing are divided in a direction perpendicular to a stacking direction of the plurality of stator cores and are configured to be coupled to the radially-outer portions of the plurality of the bobbins.

In at least one embodiment of the present disclosure, the outer housing is configured to fittingly engage with the radially-outer portions of the plurality of the bobbins.

In at least one embodiment of the present disclosure, the outer housing includes a first coupling portion configured to be coupled to one end of the radially-outer portions of the plurality of the bobbins and includes a second coupling portion formed in a shape corresponding to that of the first coupling portion and configured to be coupled to the other end of the radially-outer portions of the plurality of the bobbins.

In at least one embodiment of the present disclosure, each of the first coupling portion and the second coupling portion includes a protrusion protruding from one side of a top plate in a direction of the bobbin. The protrusion includes a coupling portion formed in an area where the protrusion is coupled to the radially-outer portions of the plurality of the bobbins.

In at least one embodiment of the present disclosure, the at least two parts include first and second coupling portions facing each other and engaging with side ends of the radially-outer portions of the plurality of bobbins. The at least two parts also include a third coupling portion disposed between the first and second coupling portions and engaging with the first and second coupling portions by fitting.

In at least one embodiment of the present disclosure, each of the first coupling portion and the second coupling portion includes a protrusion protruding from one side of a top plate toward the plurality of bobbins. The protrusion includes a coupling portion configured to be coupled to the radially-outer portions of the plurality of bobbins, and a coupling groove coupled to the third coupling portion by fitting.

In at least one embodiment of the present disclosure, the third coupling portion includes, on both sides thereof, coupling protrusions coupled to respective coupling grooves of the first coupling portion and the second coupling portion.

In at least one embodiment of the present disclosure, the outer housing includes at least two parts coupled to each other to form the outer housing. The at least two parts are divided in a direction opposite to a stacking direction of the plurality of stator cores and are configured to be coupled to the radially-outer portions of the plurality of bobbins.

In at least one embodiment of the present disclosure, each of the radially-outer portions of the plurality of bobbins includes a coupling protrusion. The outer housing includes a coupling groove configured to be coupled to the coupling protrusion.

In at least one embodiment of the present disclosure, the outer housing includes a coupling protrusion. Each of the radially-outer portions of the plurality of bobbins includes a coupling groove into which the coupling protrusion is inserted.

The AFPM motor stator according to embodiments of the present disclosure described herein may improve a space factor by securing a hollow space between coils to enable direct oil cooling and may effectively reduce the temperature of the coils by reducing the resistance of the coils to improve the performance of an AFPM motor.

### BRIEF DESCRIPTION OF THE DRAWINGS

FIG. 1 is a perspective view schematically showing the structure of an axial flux permanent magnet (AFPM) motor stator including T-shaped supports.

FIG. 2A is an exploded perspective view showing an AFPM motor stator according to an embodiment of the present disclosure.

FIG. 2B is a perspective view showing an example state in which a core portion and a housing portion of an AFPM motor stator are coupled to one another according to an embodiment of the present disclosure.

FIG. 2C is an exploded perspective view showing an inner housing and an outer housing separated from each other and from a core portion according to an embodiment of the present disclosure.

FIG. 3A is an exploded perspective view showing a core portion of an AFPM motor stator according to a first embodiment of the present disclosure.

FIG. 3B is a perspective view showing an example of a coupled state of the core portion of the AFPM motor stator according to the first embodiment of the present disclosure.

FIG. 4A is an exploded perspective view showing a core portion of an AFPM motor stator according to a second embodiment of the present disclosure.

FIG. 4B is a perspective view showing an example of a coupled state of the core portion of the AFPM motor stator according to the second embodiment of the present disclosure.

FIG. 5A is a perspective view showing an example coupling of an outer housing and a bobbin of an AFPM motor stator according to a third embodiment of the present disclosure.

FIG. 5B is a perspective view showing an example coupling of an outer housing and a bobbin of an AFPM motor stator according to a fourth embodiment of the present disclosure.

FIG. 6A is a perspective view showing an example coupling of an outer housing and a bobbin of an AFPM motor stator according to a fifth embodiment of the present disclosure.

FIG. 6B is a perspective view showing an example shape of a core portion of the AFPM motor stator according to the fifth embodiment of the present disclosure.

FIG. 7A is a perspective view showing an example coupling of an outer housing and a bobbin of an AFPM motor stator according to a sixth embodiment of the present disclosure.

FIG. 7B is a perspective view showing an example shape of a core portion of the AFPM motor stator according to the sixth embodiment of the present disclosure.

The drawings described herein are for illustration purposes only and are not intended to limit the scope of the present disclosure in any way.

### DETAILED DESCRIPTION OF THE DISCLOSURE

Hereinbelow, embodiments of the present disclosure are described in detail with reference to the accompanying drawings. The following structural or functional descriptions of embodiments are merely intended for the purpose of describing the embodiments and the embodiments may be implemented in various forms.

The embodiments are not to be construed as limited to the disclosure and should be understood to include various changes, modifications, equivalents, alternatives, and replacements within the idea and the technical scope of the disclosure.

Although terms including ordinal numbers, such as “first,” “second,” and the like, may be used herein to describe various elements, the elements are not limited by these terms. These terms are only used to distinguish one element from another. For example, a “first” element may be referred to as a “second” element, or similarly, the “second” element may be referred to as the “first” element within the scope of the right according to the concept of the present disclosure.

When an element is described as “coupled” or “connected” to another element, the element may be directly coupled or connected to the other element. However, it is to be understood that another element may be present therebetween. In contrast, when an element is described as “directly coupled” or “directly connected” to another element, it is to be understood that there are no other elements therebetween. Likewise, expressions, for example, “between” and “immediately between” and “adjacent to” and “immediately adjacent to” may also be construed as described in the foregoing.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components. Such terms do not preclude the presence or addition of one or more other features, integers, steps, operations, elements, components and/or groups thereof. When a component, device, element, part, unit, portion, or the like of the present disclosure is described as having a purpose or performing an operation, function, or the like, the component, device, element, part, unit, portion, or the like should be considered herein as being “configured to” meet that purpose or to perform that operation or function.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure. Such terms are not to be interpreted in an idealized or overly formal sense unless expressly so defined herein.

Also, when an embodiment is implemented differently, functions or operations specified within a specific block may occur differently from the order specified in the flowchart of the embodiment. For example, two consecutive blocks may actually be performed substantially simultaneously, or the blocks may be performed in reverse order depending on the functions or operations involved.

Hereinbelow, axial flux permanent magnet (AFPM) motor stators according to embodiments of the present disclosure are described in detail with reference to the accompanying drawings.

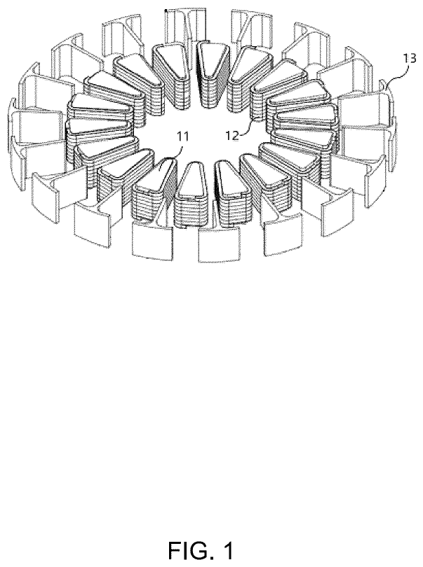

FIG. 1 is a perspective view schematically showing the structure of an axial flux permanent magnet (AFPM) motor stator including T-shaped supports. The T-shaped supports 13 may each be disposed between coils 12 surrounding an outer circumferential surface of the stator cores 11 to engage therewith.

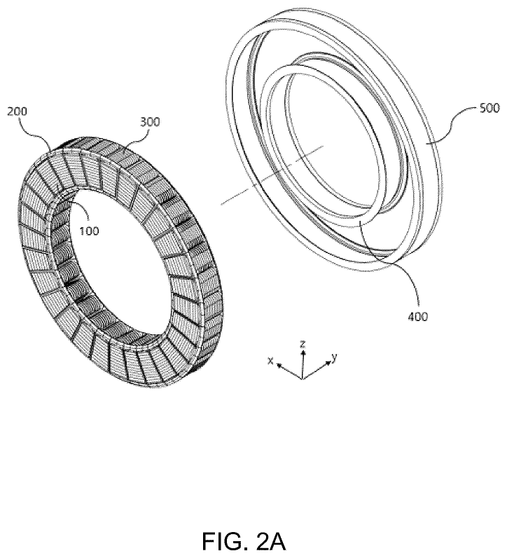

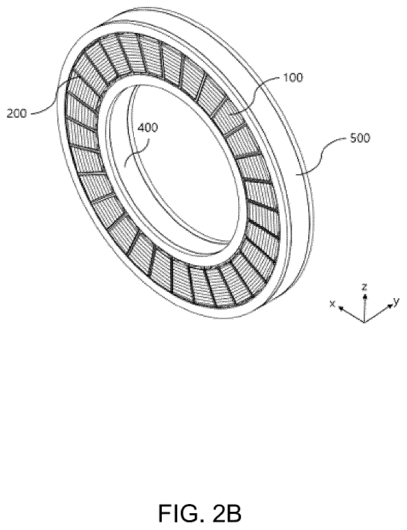

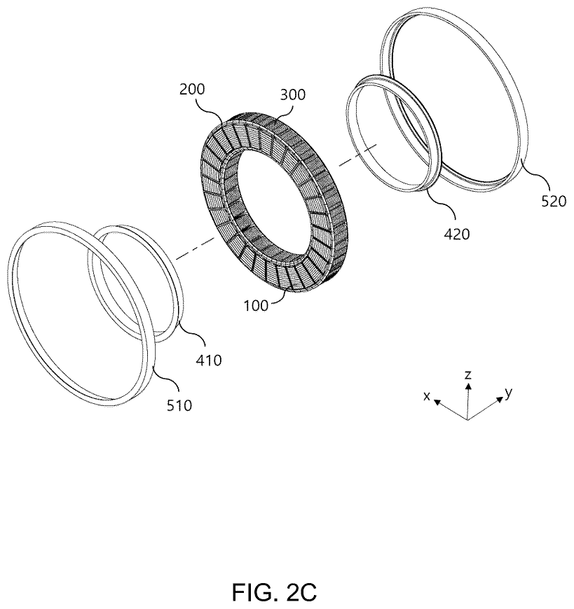

FIG. 2A is an exploded perspective view showing an AFPM motor stator according to an embodiment of the present disclosure. FIG. 2B is a perspective view showing an example state in which a core portion and a housing portion of an AFPM motor stator are coupled according to an embodiment of the present disclosure. FIG. 2C is an exploded perspective view showing how an inner housing and an outer housing that are separated from each other are coupled to a core portion according to an embodiment of the present disclosure.

According to an embodiment of the present disclosure, an AFPM motor stator may include (e.g., may be divided into) a plurality of core portions arranged in a circular configuration and a housing portion. Each core portion may include a stator core 100 stacked in a tapered shape, a bobbin 200 coupled to an outer surface of the stator core 100 and supporting the stator core 100, and a coil 300 wound along an outer circumferential surface of the bobbin 200.

According to an embodiment of the present disclosure, the housing portion of the AFPM motor stator may include an inner housing 400 and an outer housing 500. The inner and outer housings 400 and 500 face each other and are coupled to each other to support a lower side (or radially-inner side) and an upper side (or radially-outer side) of the core portion, respectively. The inner housing 400 may be provided in a shape of a hollow cylinder and support a bottom portion of a plurality of bobbins 200 on which the coil 300 is wound. The outer housing 500 may surround and support a top portion of the plurality of bobbins 200 on which the coil 300 is wound. The inner housing 400 and the outer housing 500 may each be divided into two parts and coupled to both sides of the core portion. In other words, the inner housing 400 may be divided into two housings 410 and 420 to be coupled to face in a direction (e.g., a “y” axis direction) perpendicular to a stacking direction (e.g., an “x” axis direction or a “z” axis direction) of the stator core 100. Similarly, the outer housing 500 may be divided into two housings 510 and 520 to be coupled in the “y” axis direction.

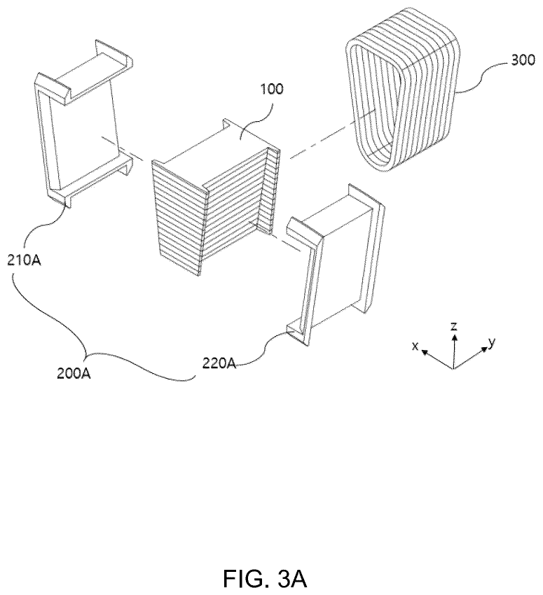

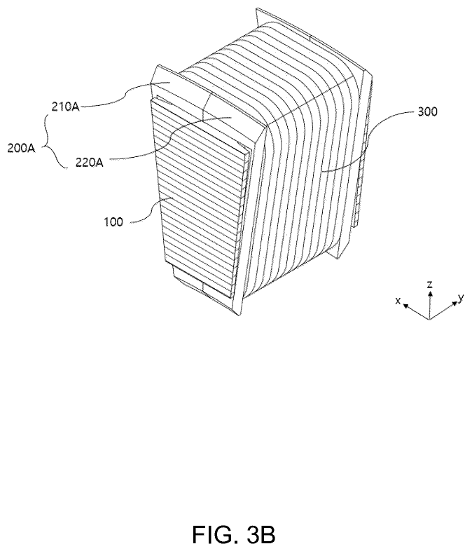

FIG. 3A is an exploded perspective view showing a core portion of an AFPM motor stator according to a first embodiment of the present disclosure. FIG. 3B is a perspective view showing an example coupled state of the core portion of the AFPM motor stator according to the first embodiment of the present disclosure.

As shown, the stator core 100 may be provided in a structure in which “I”-shaped core plates of different sizes are stacked in a “z” axis direction. A core plate stacked on top of another core plate may be relatively larger than the core plate stacked below, which may form an overall tapered shape.

According to an embodiment, a bobbin 200A may include a first bobbin 210A and a second bobbin 220A. The first and second bobbins 210A and 220A are horizontally (i.e. in the circumferential direction with respect to the circular arrangement) divided along a dividing line with respect to the stator core 100 and have a symmetrical shape to each other. The first bobbin 210A and the second bobbin 220A may be coupled on both sides of the stator core 100 in a width direction, i.e. an “x” axis direction and may be considered to define two pieces, parts, or “halves” of the bobbin 200A.

The bobbin 200A may be formed of engineering plastics that have an insulating property and high stiffness for supporting the stator. The engineering plastics, a high-performance plastic material that may replace a metal or ceramic material, may be relatively lightweight compared to the metal or ceramic material and may thus be more advantageous in lightening a product in weight. The bobbin 200A may be formed by an insert injection method in which the stator core 100 is placed in a mold and the engineering plastic material is injected.

The inner housing 400 and the outer housing 500 may be formed of the same material as the bobbin 200A. A top portion (i.e. radially-outer portion) and a bottom portion (i.e. radially-inner portion) of the bobbin 200A may each have a structure for coupling, such as, for example, an oblique and concave-convex shaped structure. The structure may be coupled to the inner housing 400 and the outer housing 500 by any one of plastic fusion methods including, for example, laser fusion, bonding, ultrasonic fusion, and the like.

The coil 300 may be wound along an outer circumferential surface of the bobbin 200A, with the bobbin 200A coupled to both sides of the stacked stator core 100.

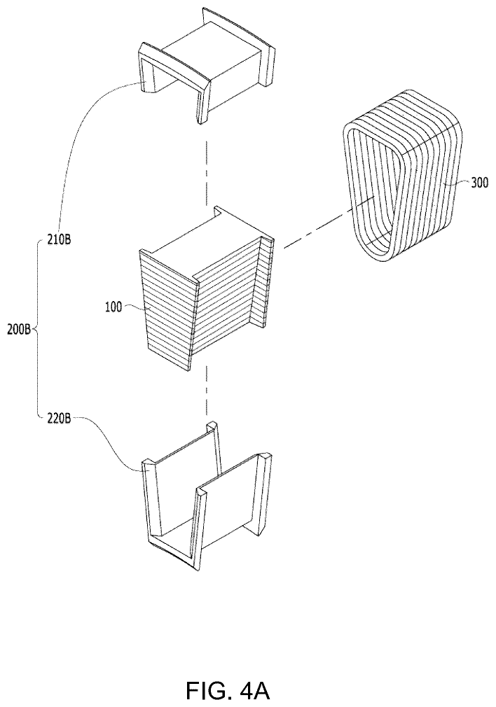

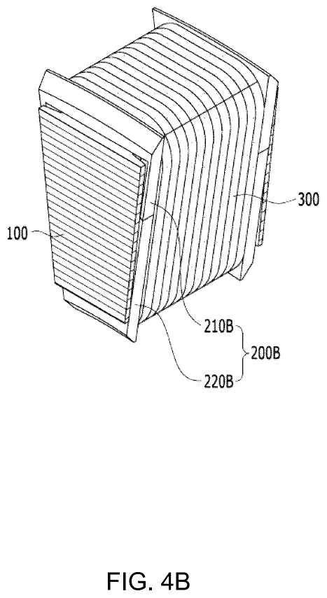

FIG. 4A is an exploded perspective view showing a core portion of an AFPM motor stator according to a second embodiment of the present disclosure. FIG. 4B is a perspective view showing an example coupled state of the core portion of the AFPM motor stator according to the second embodiment of the present disclosure. Unlike an embodiment described above with reference to FIGS. 3A and 3B, a bobbin 200B according to this embodiment may be divided into a first bobbin 210B disposed at the top and a second bobbin 220B disposed at the bottom (i.e. the first bobbin 210B corresponds to a radially outer portion of the bobbin 200B and the second bobbin 220B to a radially inner portion thereof). As shown, the bobbin 200B may be divided into the first bobbin 210B and the second bobbin 220B with respect to a stacking direction of the stator core 100. A dividing position may be above with respect to a middle portion of the stacking direction of the stator core 100. The first bobbin 210B and the second bobbin 220B may be coupled to face each other from the top and the bottom of stator core 100.

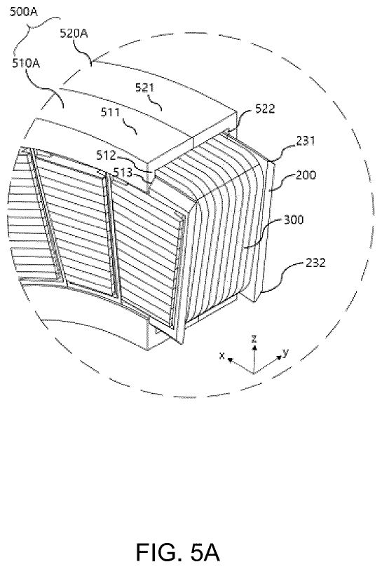

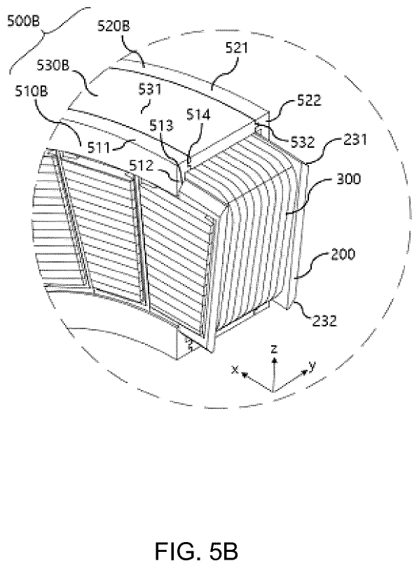

FIG. 5A is a perspective view showing an example coupling of an outer housing and a bobbin of an AFPM motor stator according to a third embodiment of the present disclosure.

As shown, an outer housing 500A may be divided, as shown in FIG. 2C, in a direction (e.g., a “y” axis direction) perpendicular to a stacking direction (e.g., an “x” axis direction and a “z” axis direction) of the stator core 100 and coupled to a top portion 231 of the bobbin 200.

According to the third embodiment, the outer housing 500A may include a first coupling portion 510A coupled to one end of the top portion 231 of the bobbin 200. The outer housing 500A may include a second coupling portion 520A provided in a shape corresponding to the first coupling portion 510A and coupled to the other end of the top portion 231 of the bobbin 200.

The first coupling portion 510A may include a first protrusion 512 that protrudes from one side of a top plate 511 toward the bobbin 200. The first protrusion 512 may have a coupling portion 513 in an area that is coupled to the top portion 231 of the bobbin 200. The shape of the coupling portion 513 may correspond to that of the top portion 231 of the bobbin 200. A bottom portion 232 of the bobbin 200 may have the same shape as the top portion 231 and may be coupled to the inner housing 400 having a corresponding shape.

The second coupling portion 520A may include a second protrusion 522 that protrudes from one side of a top plate 521 toward the bobbin 200. Although not shown, the second protrusion 522 may also have a coupling portion (not shown) in an area that is coupled to the top portion 231 of the bobbin 200.

Although not shown, the shape of the inner housing 400 that is coupled to support the bottom portion of the bobbin 200 may also be provided in a similar shape to that of the outer housing 500A.

FIG. 5B is a perspective view showing an example coupling of an outer housing and a bobbin of an AFPM motor stator according to a fourth embodiment of the present disclosure. According to the fourth embodiment, an outer housing 500B of an AFPM motor stator may be divided into three in a “y” axis direction. The outer housing 500B may include a first coupling portion 510B coupled to the top portion 231 on one side of the bobbin 200. The outer housing 500B may include a second coupling portion 520B coupled to the top portion 231 on the other side of the bobbin 200 corresponding to the first coupling portion 510B. The outer housing 500B may include a third coupling portion 530B disposed between the first coupling portion 510B and the second coupling portion 520B to engage with the first coupling portion 510B and the second coupling portion 520B by fitting.

On both sides of the third coupling portion 530B, coupling portions 532 to be coupled to the first coupling portion 510B and the second coupling portion 520B may be formed, respectively. On the first coupling portion 510B and the second coupling portion 520B, coupling grooves 514 into which the coupling portions 532 are inserted respectively may be formed.

Although not shown, in contrast to the above coupling structure, a structure may also be possible in which coupling grooves are formed on both sides of the third coupling portion 530B and in which coupling protrusions to be inserted into the coupling grooves are formed on the first coupling portions 510B and the second coupling portion 520B, respectively.

Although not shown, the inner housing 400 that is coupled to support the bottom portion of the bobbin 200 may be provided in a similar shape to that of the outer housing 500B.

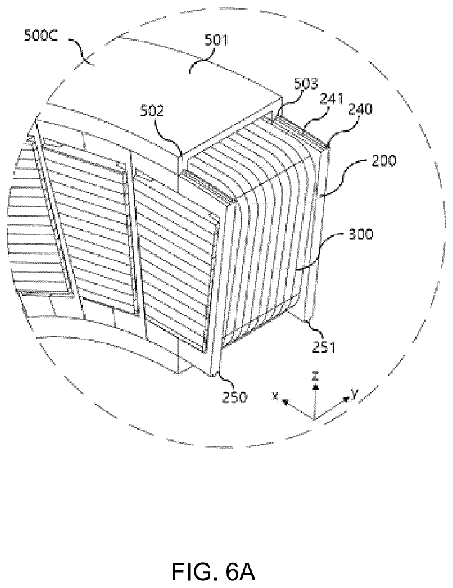

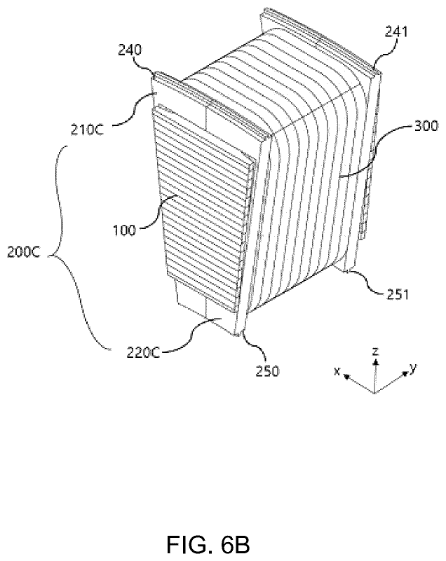

FIG. 6A is a perspective view of an example coupling of an outer housing and a bobbin of an AFPM motor stator according to a fifth embodiment of the present disclosure. FIG. 6B is a perspective view of an example shape of a core portion of the AFPM motor stator according to the fifth embodiment of the present disclosure. FIG. 6c illustrates an example shape of the core portion of the AFPM motor stator according to a modified embodiment of the fifth embodiment.

According to the fifth embodiment, an outer housing 500C of an AFPM motor stator, with the same curvature as a top portion 240 of a bobbin 200C, may be coupled to the top portion 240 of the bobbin 200C in a “z” axis direction by fitting. An extension 502 extending in the “z” axis direction from a body 501 of the outer housing 500C toward the bobbin 200C may have, at its lower end, a coupling groove 503 in an area coupled to the top portion 240 of the bobbin 200C. A coupling protrusion 241 inserted into the coupling groove 503 may be formed on the top portion 240 of the bobbin 200C. A coupling protrusion 251 inserted into a coupling groove (not shown) formed in the inner housing 400 having a curvature corresponding to that of the bottom portion 250 of the bobbin 200C may be formed on the bottom portion 250 of the bobbin 200C. The first bobbin 210C and the second bobbin 220C may be of the same shape with different curvatures.

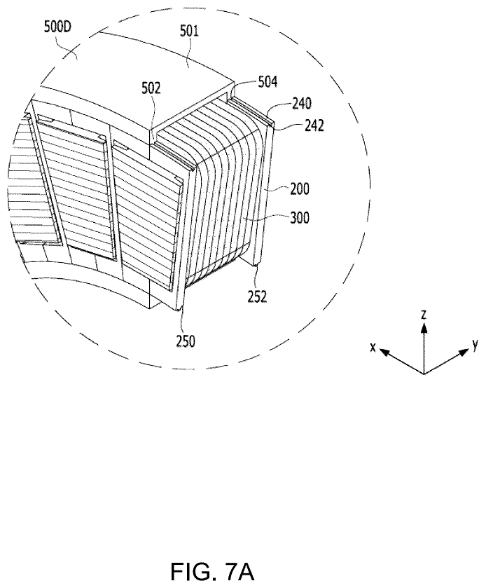

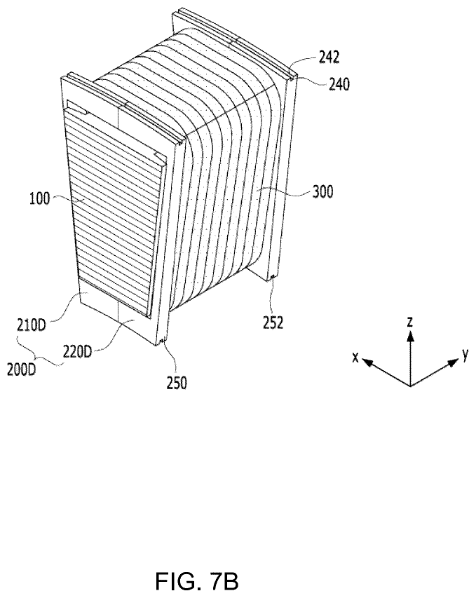

FIG. 7A is a perspective view showing an example coupling of an outer housing and a bobbin of an AFPM motor stator according to a sixth embodiment of the present disclosure. FIG. 7B is a perspective view showing an example shape of a core portion of the AFPM motor stator according to the sixth embodiment of the present disclosure.

According to the sixth embodiment, an outer housing 500D of an AFPM motor stator, with the same curvature as a top portion 240 of a bobbin 200D, may be coupled to the top portion 240 of the bobbin 200D in a “z” axis direction by fitting.

Unlike the fifth embodiment, an extension 502 extending in the “z” axis direction from a body 501 of the outer housing 500D towards the bobbin 200D may have, at its lower end, a coupling protrusion 504 in an area coupled to the top portion 240 of the bobbin 200D. A coupling groove 242 into which the coupling protrusion 504 is inserted may be formed on the top portion 240 of the bobbin 200D.

A bottom portion 250 of the bobbin 200D may have a structure formed to fit into the inner housing 400 having a curvature corresponding to the bottom portion 250 of the bobbin 200D. As shown, a coupling groove 252 may be formed in the same manner as the top portion 240. When there is a coupling groove (not shown) formed in the inner housing 400, it may have the shape of a coupling protrusion (not shown).

According to an embodiment of the present disclosure, a stator of an AFPM motor may provide a direct oil cooling method in which oil directly cools a coil. The coil may be cooled by impregnating the entire coil with oil while maintaining airtightness inside a support of the stator through molding. It may enable a support structure that allows oil to directly cool the coil, which may be flexible to the thermal conductivity characteristics. In addition, an “I”-shaped core around which the coil is wound may be inserted between a plurality of blades through fitting to be in close contact with an outer circumferential surface of a body, thereby preventing an increase in a stacking length between the stator and a rotor and reducing the torque.

While the present disclosure includes example embodiments, it should be apparent to one of ordinary skill in the art that various changes in form and details may be made in these embodiments without departing from the spirit and scope of the claims and their equivalents.

What is claimed is:

1. An axial flux permanent magnet (AFPM) motor stator, comprising:
a plurality of stator cores in a circular arrangement, each of the plurality of stator cores shaped in a tapered shape;
a plurality of bobbins each divided to be coupled to an outer side of each of the plurality of stator cores;
a plurality of coils each wound along an outer circumferential surface of each of the plurality of bobbins;
an inner housing having a shape of a hollow cylinder and supporting radially-inner portions of the plurality of bobbins each wound by a coil of the plurality of coils; and
an outer housing surrounding and supporting radially-outer portions of the plurality of bobbins each wound by the coil.

2. The AFPM motor stator of claim 1, wherein each of the plurality of bobbins comprises two pieces coupled to each other to form each of the plurality of bobbins in a circumferential direction with respect to the circular arrangement.

3. The AFPM motor stator of claim 1, wherein each of the plurality of bobbins comprises two pieces coupled to each other to form each of the plurality of bobbins, and wherein a dividing line divides the two pieces transverse to a width direction of the each of the plurality of stator cores.

4. The AFPM motor stator of claim 1, wherein each of the plurality of bobbins comprises a first half bobbin and a second half bobbin coupled to each other to form each of the plurality of bobbins with respect to a stacking direction of the plurality of stator cores.

5. The AFPM motor stator of claim 4, wherein a dividing line of the first half bobbin and the second half bobbin is above a middle the each of the plurality of bobbins in the stacking direction.

6. The AFPM motor stator of claim 1, wherein the plurality of bobbins is coupled to the inner housing and the outer housing by a plastic fusion, the plastic fusion including any one of laser fusion, bonding, or ultrasonic fusion.

7. The AFPM motor stator of claim 1, wherein each of the plurality of bobbins is made from engineering plastic.

8. The AFPM motor stator of claim 7, wherein each of the plurality of bobbins is insert injection molded by a corresponding stator core being placed into a mold and by the engineering plastic being injected into the mold.

9. The AFPM motor stator of claim 7, wherein the inner housing and the outer housing are formed of the engineering plastic.

10. The AFPM motor stator of claim 1, wherein the inner housing comprises at least two parts coupled to each other to form the inner housing, and wherein the at least two parts are divided in a direction perpendicular to a stacking direction of the plurality of stator cores.

11. The AFPM motor stator of claim 1, wherein the outer housing comprises at least two parts coupled to each other to form the outer housing, and wherein the at least two parts are divided in a direction perpendicular to a stacking direction of the plurality of stator cores and are configured to be coupled to the radially-outer portions of the plurality of the bobbins.

12. The AFPM motor stator of claim 11, wherein the outer housing is configured to fittingly engage with the radially-outer portions of the plurality of the bobbins.

13. The AFPM motor stator of claim 12, wherein the outer housing comprises:
a first coupling portion configured to be coupled to one ends of the radially-outer portions of the plurality of the bobbins; and
a second coupling portion formed in a shape corresponding to that of the first coupling portion and configured to be coupled to the other ends of the radially-outer portions of the plurality of the bobbins.

14. The AFPM motor stator of claim 13, wherein:
each of the first coupling portion and the second coupling portion comprises a protrusion protruding from one side of a top plate in a direction of the bobbin; and
the protrusion includes a coupling portion formed in an area where the protrusion is coupled to the radially-outer portions of the plurality of the bobbins.

15. The AFPM motor stator of claim 12, wherein the at least two parts comprise:
first and second coupling portions facing each other and engaging with side ends of the radially-outer portions of the plurality of bobbins; and
a third coupling portion disposed between the first and second coupling portions and engaging with the first and second coupling portions by fitting.

16. The AFPM motor stator of claim 15, wherein:
each of the first coupling portion and the second coupling portion comprises a protrusion protruding from one side of a top plate toward the plurality of bobbins; and
the protrusion comprises a coupling portion configured to be coupled to the radially-outer portions of the plurality of bobbins, and a coupling groove coupled to the third coupling portion by fitting.

17. The AFPM motor stator of claim 16, wherein the third coupling portion comprises, on both sides thereof, coupling protrusions coupled to respective coupling grooves of the first coupling portion and the second coupling portion.

18. The AFPM motor stator of claim 1, wherein the outer housing comprises at least two parts coupled to each other to form the outer housing, and wherein the at least two parts are divided in a direction opposite to a stacking direction of the plurality of stator cores and are configured to be coupled to the radially-outer portions of the plurality of bobbins.

19. The AFPM motor stator of claim 18, wherein each of the radially-outer portions of the plurality of bobbins comprises a coupling protrusion, and wherein the outer housing comprises a coupling groove configured to be coupled to the coupling protrusion.

20. The AFPM motor stator of claim 18, wherein the outer housing comprises a coupling protrusion, and wherein each of the radially-outer portions of the plurality of bobbins comprises a coupling groove into which the coupling protrusion is inserted.
